(19) United States
(12) Patent Application Publication
(10) Pub. No.: US 2025/0375801 A1
(43) Pub. Date: Dec. 11, 2025

(54) AIR INTAKE MANIFOLD WITH ADJUSTABLE SHUTTERS

(71) Applicant: Illinois Tool Works Inc., Glenview, IL (US)

(72) Inventors: John Gorczyca, Lansdale, PA (US); Richard Rodrigo, Chalfont, PA (US)

(21) Appl. No.: 19/222,342

(22) Filed: May 29, 2025

Related U.S. Application Data
(60) Provisional application No. 63/657,270, filed on Jun. 7, 2024.

(51) Int. Cl. B08B 5/04; B08B 1/12

(52) U.S. Cl. CPC B08B 5/046; B08B 1/12

(57) ABSTRACT

A vacuum system is provided for cleaning an object (e.g., web and sheet cleaning). The system includes an air manifold with an inlet flange configured to receive contaminants and air. One or more shutters can be mounted to the inlet flange and arranged to adjust a size of an air inlet of the inlet flange. This is accomplished by arranging one or more shutters at one or more locations along the length of the inlet flange. Thus, a position of the shutters along the inlet regulates airflow into the air manifold, thereby providing a desired amount of exhaust at a desired location along the inlet. In operation, the air manifold is configured to draw air through the intake flange.

### CROSS REFERENCE TO RELATED APPLICATIONS

This application is a Non-Provisional Patent Application claiming priority to U.S. Provisional Patent Application No. 63/657,270 entitled “Air Intake Manifold With Adjustable Shutters” filed Jun. 7, 2024, which is herein incorporated by reference in its entirety.

### BACKGROUND

A variety of systems are configured to clean sheets or continuous material, as conveyed via roller. For example, a vacuum device can remove dust from the material as it passes through the system. In some systems, the vacuum includes a plenum or manifold with an air intake to receive the dust, the manifold having a fixed outlet and/or hose to exhaust air carrying the dust. As may be appreciated, systems with enhanced flexibility provide additional value for customers. Thus, systems and device to clean web and sheet material with added product flexibility is desirable.

Further limitations and disadvantages of conventional and traditional approaches will become apparent to one of skill in the art, through comparison of such systems with the present disclosure as set forth in the remainder of the present application with reference to the drawings.

### BRIEF SUMMARY

The present disclosure relates generally to web and sheet cleaning systems and, more particularly, to web and sheet cleaning systems with adjustable shutters.

These and various other advantages, aspects and novel features of the present disclosure, as well as details of an illustrated embodiment thereof, will be more fully understood from the following description and drawings.

### BRIEF DESCRIPTION OF THE DRAWINGS

Certain aspects of embodiments disclosed herein by way of example are summarized below. It should be understood that these aspects are presented merely to provide the reader with a brief summary of certain forms an invention disclosed and/or claimed herein might take, and that these aspects are not intended to limit the scope of any invention disclosed and/or claimed herein. Indeed, any invention disclosed and/or claimed herein may encompass a variety of aspects that may not be set forth below.

FIG. 1 is a perspective view of an example vacuum system for cleaning an object, in accordance with aspects of this disclosure.

FIG. 2 is an end view of the example vacuum system of FIG. 1, in accordance with aspects of this disclosure.

FIG. 3 is a perspective view of an example shutter, in accordance with aspects of this disclosure.

FIG. 4 is a detailed end view of the example vacuum system of FIG. 1, in accordance with aspects of this disclosure.

FIGS. 5A to 5C illustrate perspective views of example shutters, in accordance with aspects of this disclosure.

FIGS. 6A and 6B illustrate perspective views of example shutters with perforations, in accordance with aspects of this disclosure.

FIG. 7 is a perspective view of the example vacuum system of FIG. 1 employing a plurality of shutters, in accordance with aspects of this disclosure.

The figures are not necessarily to scale. Where appropriate, similar or identical reference numbers are used to refer to similar or identical components.

### DETAILED DESCRIPTION

The present disclosure relates generally to web and sheet cleaning systems and, more particularly, to web and sheet cleaning systems with one or more shutters adjusting an opening size for airflow at an air inlet.

A vacuum system is provided for cleaning an object (e.g., web and sheet cleaning). The system includes an air manifold with an inlet flange configured to receive contaminants and air. One or more shutters can be mounted to the inlet flange and arranged to adjust a size of an air inlet of the inlet flange. This is accomplished by arranging one or more shutters at one or more locations along the length of the inlet flange. Thus, a position of the shutters along the inlet regulates airflow into the air manifold, thereby providing a desired amount of intake at a desired location along the inlet. In operation, the air manifold is configured to draw air through the intake flange, removing dust and air from the object being cleaned, which is exhausted to a dust collecting vacuum system.

Manufacturing processes for web and sheet materials (e.g., paper, film, foil materials, etc.) create particles that can contaminate the web. Contact and separation of the material with rollers of the machinery tends to generate static electricity, resulting in electrostatic adhesion of the contaminants (e.g., dust, lint, etc.), thereby bonding the contaminants to a surface of the material. Furthermore, the faster the machine moves the material, the more complicated this problem becomes. For example, contaminated surfaces tend to cause defects, which results in quality problems and costly additional work.

Such vacuum systems typically employ an air manifold or plenum with a single inlet along a length of the material. The inlet therefore provides suction into the air manifold at all points along the inlet flange, at substantially the same pressure and/or volume. Thus, changes to the suction pattern are not available, limiting the ability of such vacuum systems to receive different materials under different operating conditions.

By including one or more shutters, installation of the vacuum system can be configured in a variety of ways. This includes selecting areas along the length of the inlet flange to have greater airflow compared with other areas. This may be useful for materials of different types, thicknesses, and/or roll speeds, as a list of non-limiting examples. Inclusion of the disclosed example shutters on the inlet flange (and/or shutters with perforations) causes a change in air intake distribution by a variable amount (e.g., 20-70%) of the open air inlet.

Additionally, as one or more shutters can be used to change the suction profile, different sized materials can be used on a single system while maintaining a high level of suction/airflow through the inlet flange, thereby enhancing the system's cleaning power of the material.

In disclosed examples, a vacuum system for cleaning an object includes an inlet flange having a first end and a second end, the inlet flange configured to connect to a vacuum collector system; and one or more shutters configured to be mounted to the inlet flange and arranged to adjust a size of an air inlet of the inlet flange at one or more locations along the length.

In some examples, the inlet flange further comprises one or more flange lips arranged on one or more sides of the air inlet along the length of the inlet flange. In examples, each shutter of the one or more shutters includes one or more clips on one or more sides of the shutter, the one or more clips configured to secure the shutter to the one or more flange lips.

In some examples, the one or more flange lips includes a first flange lip and a second flange lip, the first flange lip arranged along a first side of the inlet flange and the second flange lip arranged along a second side of the inlet flange.

In some examples, the air inlet is arranged between the first flange lip and the second flange lip along the length of the inlet flange.

In some examples, the one or more clips includes a first clip and a second clip, the first clip arranged along a first side of the shutter and the second clip arranged along a second side of the shutter.

In some examples, the one or more shutters are configured to be mounted on the inlet flange by mounting the first clip to the first flange lip and the second clip to the second flange lip.

In some examples, each of the one or more shutters further comprises a base between the first clip and the second clip, the base configured to at least partially block access to the air inlet when the one or more shutters are mounted to the inlet flange.

In some examples, each of the one or more shutters further comprises one or more crimps at an end of the first or second clip of the shutter, the one or more crimps configured to connect to the first or second flange lip at the first or second end of the inlet flange to fix a position of the shutter at the first or second end.

In some examples, the one or more shutters are removably mounted to the inlet flange.

In some examples, the one or more shutters includes a first shutter and a second shutter, the first shutter configured to be mounted at the first or second end of the inlet flange, and the second shutter configured to be mounted to the inlet flange between the first and second ends. In examples, the system further includes a fastener to clamp the second shutter to the inlet flange to fix a position of the second shutter on the inlet flange.

In some examples, the one or more shutters includes a first shutter and a second shutter, the first shutter having a first length greater than a second length of the second shutter.

In some disclosed examples, an adjustable vacuum system for cleaning an object includes an inlet flange having a first end and a second end, the inlet flange configured to connect to a vacuum collector system; and one or more shutters comprising one or more perforations, the one or more shutters configured to be mounted to the inlet flange and arranged to adjust a size of an air inlet of the inlet flange at one or more locations along the length.

In some examples, the one or more perforations includes one or more holes through a base of the one or more shutters. In examples, the one or more holes are in the shape of a circle, a rectangle, a triangle, a square, or a slit.

In some examples, the one or more perforations are distributed in a regular pattern about the base.

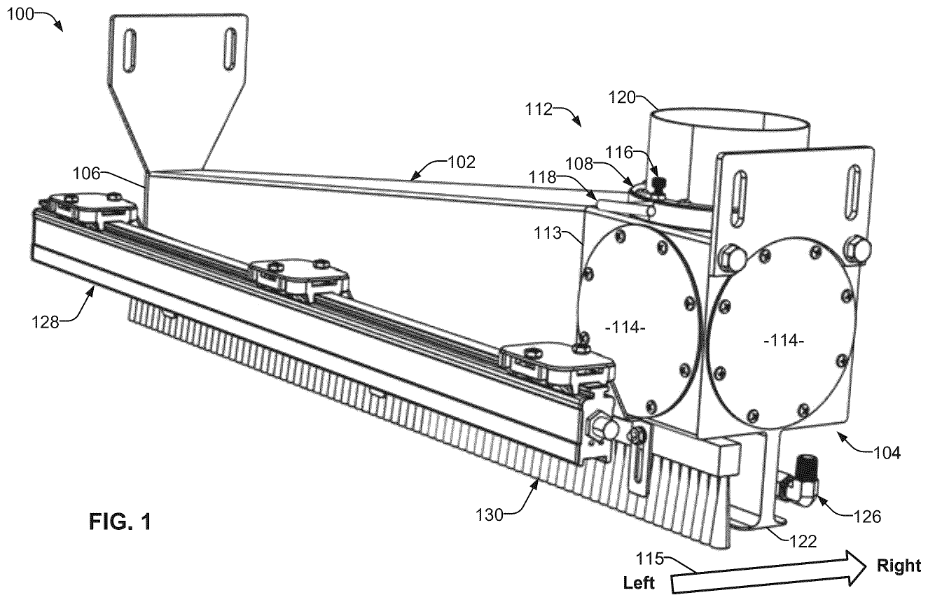

Turning now to the drawings, FIG. 1 illustrates a vacuum system 100 that may incorporate one or more aspects of the presently disclosed components. The system 100 includes an air manifold 102 with a first end 104 and a second end 106. As shown, a damper coupling 112 is arranged through an outlet of a plurality of outlets of a frame 113 at the first end 104, the plurality of outlets to exhaust pressurized air (e.g., drawn to a vacuum source via a hose or conduit—not shown). Unused outlets are blocked with plates 114

The outlets are configured to receive a damper coupling 112 that includes a damper collar 108 to support a damper 120, and/or a blank cover 114. Thus, a damper coupling 112 may be mounted to the air manifold 102 via the frame, and provide four (4) outlets, one or more of which can be fitted with a damper or a blank cover. In some examples, the damper coupling 112 is removably mountable to the air manifold 102 at the frame 113.

The disclosed vacuum system 100 can additionally or alternatively include one or more of an air tube 126, a static bar 128, and/or a brush 130. For example, as a material 115 is cleaned by the system 100, it generally moves from left to right. The material is first exposed to ions from the static bar 128, then (optionally) physically contacted by the brush 130 to loosen any contaminants on a surface of the material. Pressurized air from the air tube 126 is directed generally toward the material surface and an inlet flange 122, which provides airflow to aid in removal of the contaminants/contaminated air as the material traverses the system.

Thus, the vacuum system 100 combines a compressed air, static elimination, and/or contact brushes with a vacuum exhaust (at the inlet flange) to agitate the material, thereby removing the static bond between the material and the contaminants. This serves to evacuate surface particulates from the material (e.g., down to approximately 20 microns in size).

As shown in FIG. 1, the damper 112 can include a lever 118 to rotate a plate or blade, which changes a position of the plate within the outlet. Once a desired position is achieved, an adjustable fastener 116 can be activated to set the position of the lever 118, and thereby the plate. This ensures a consistent opening through which air flows during a cleaning operation.

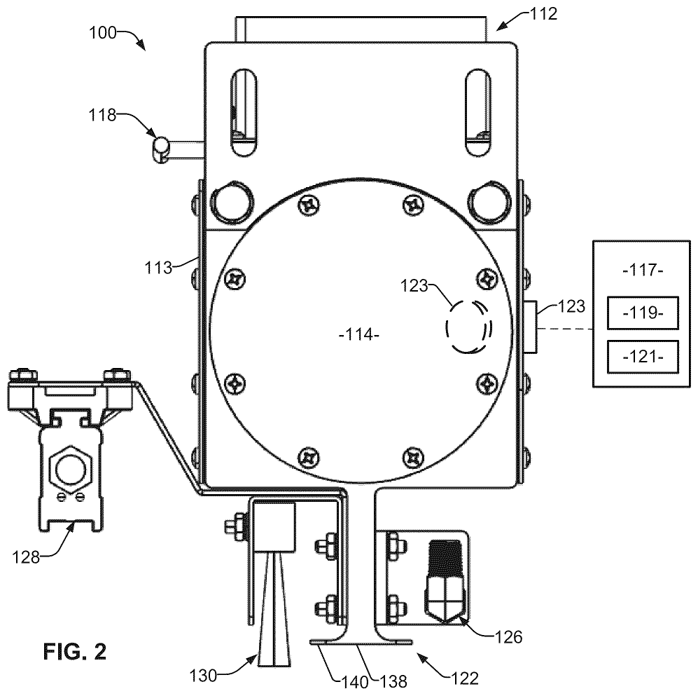

FIG. 2 illustrates an end view of the vacuum system 100, showing the inlet flange 122, having an air inlet 138 and flange lips 140 on opposite sides of the air inlet 138 along a length of the inlet flange 122.

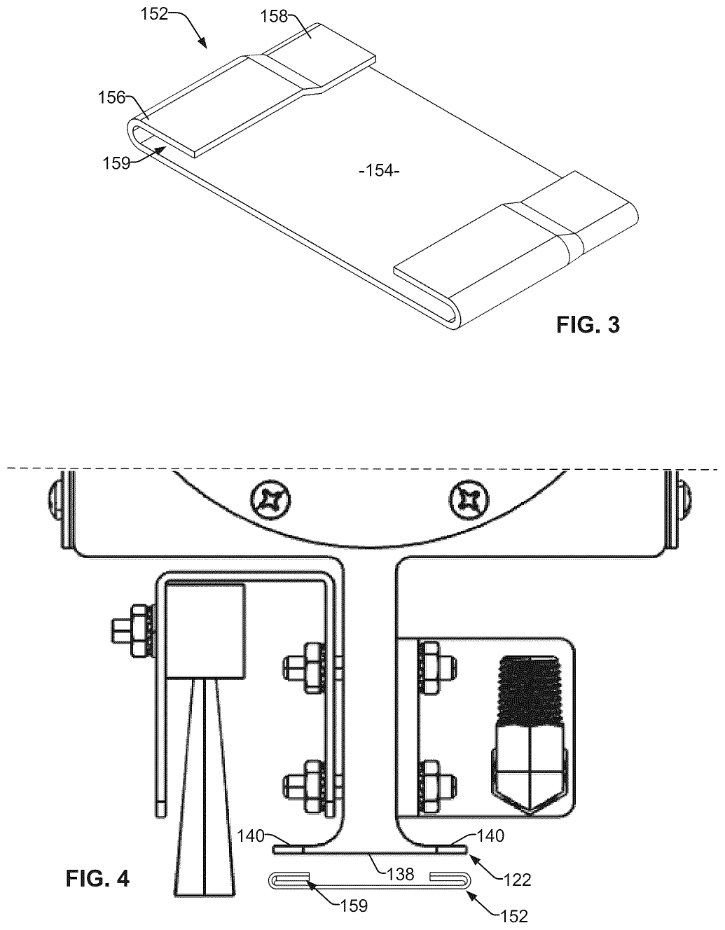

In order to regulate the air intake into the air inlet 138, one or more shutters 152 can be arranged along the inlet flange 122. As shown in FIG. 3, the shutter 152 is formed with a base 154 extending between clips 156 on either end. The clips 156 of the shutter 152 can be formed of a single material, and bent over itself to form a channel 159. As shown in FIG. 4, the shutter 152 can be placed over the inlet flange 122, such that the flange lips 140 slide into the channels 159, while the base 154 covers a portion of the air inlet 138 corresponding to the length of the shutter 152.

Returning to FIG. 3, one or more crimps 158 can be formed at one end of the shutter 152. The crimps 158 narrow the channel 159, such that the flange lips 140 make contact with an interior of the crimps 158, creating friction between the shutter and the inlet flange. At installation, the friction can cause the shutter to hold the desired position on the inlet flange, thereby decreasing the opening at the air inlet.

Returning to FIG. 2, in some examples the vacuum system 100 can include one or more sensors 123. For instance, the sensors may provide measurements corresponding to airflow (e.g., a volume of air passing through the damper) and/or a vacuum level (e.g., a pressure differential between the manifold and the environment). The measurements and/or data from the sensors 123 can be provided to a system 117, which may include a processor or control circuitry 119 to receive data from one or more sensors 123.

In some examples, the sensor may be configured to measure one or more characteristics (e.g., size, shape, composition, flow rate, concentration, etc.) of contaminants passing through the system 100. For instance, the sensor may be a transmissive light detector configured to measure contaminants (e.g., particles, dust, etc.) flowing through the air manifold and/or the dampers using optical sensing techniques (e.g., diffraction, laser scanning, etc.). In this manner, use of the sensor provides measurements of air flow and/or contamination level entering the system 100 from the processed material. One or more of the sensors 123 may be arranged at one or more locations on or around the vacuum system. For example, the sensors may be arranged on the housing of the system, within and/or about one or more inlets and/or outlets.

Based on the measurements, the control circuitry 119 can determine a current amount of airflow, and provide instructions to an installer as to the amount of change in the size of the outlet opening needed to achieve a desired airflow. For example, the control circuitry 119 can query a list of air inlet opening sizes corresponding to a desired amount of airflow and/or a particular type of material and/or cleaning operation. Based on the query, and/or a comparison with measured data, the control circuitry 119 can provide guidance to a user device (e.g., user interface, remote computer, etc.) providing information to the installer. The information can correspond to a desired position and/or size of a shutter needed to reach a desired airflow, thereby providing guidance for manual adjustments.

Although illustrated with a brush 130, in some examples the system 100 can be used without a brush (e.g., a non-contact vacuum system).

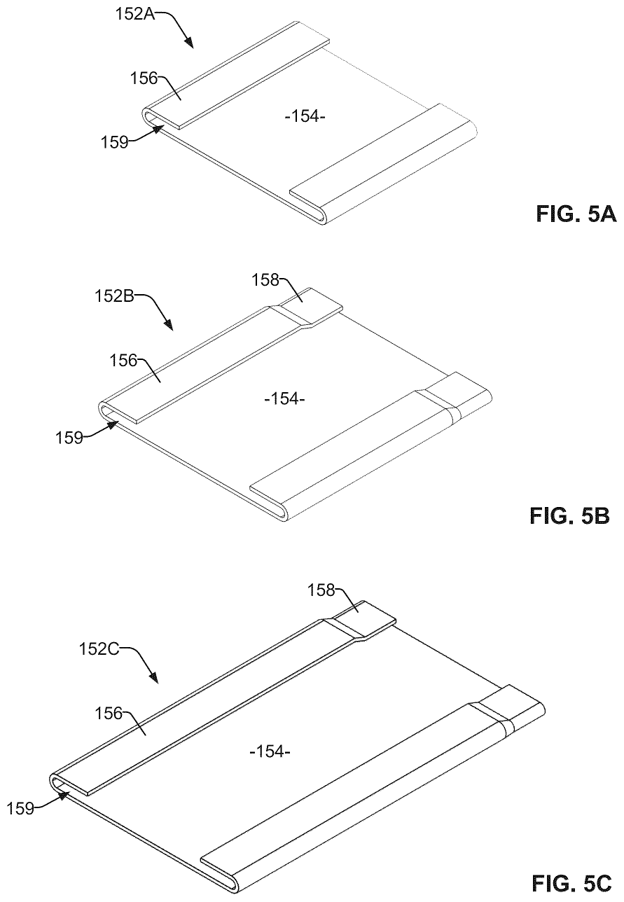

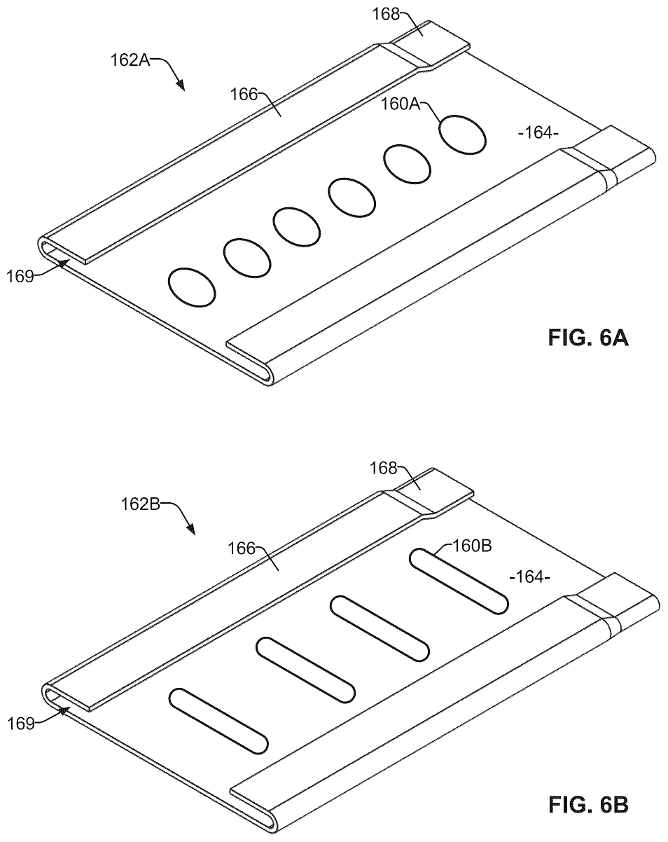

FIGS. 5A to 5C illustrate perspective views of a variety of example shutters. FIG. 5A illustrates shutter 152A, which is formed without crimps. This allows for the shutter 152A to be arranged at any location along the length of the inlet flange 122. FIGS. 5B and 5C illustrate shutters 152B and 152C, respectively, of varying sizes, each with a base 154, clips 156, crimps 158, and a channel 159. Although illustrated with crimps, in some examples shutters 152B and 152C can be formed without crimps, such that they can be arranged at positions along the length of the inlet flange 122.

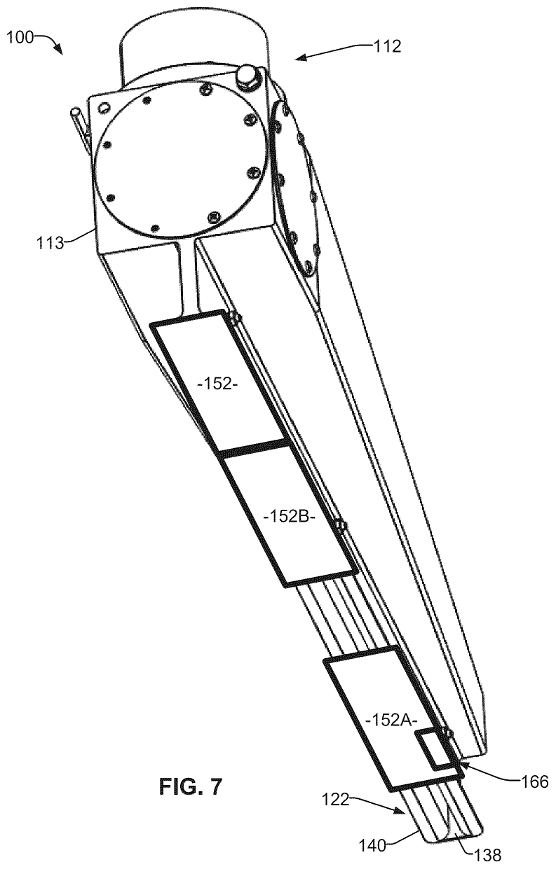

FIGS. 6A and 6B illustrate perspective views of example shutters with perforations. For example, each shutter 162A and 162B includes a base 164, clips 166, crimps 168, and a channel 169. Additionally, shutter 162A includes substantially oval or round perforations 160A, which allow some airflow through base 164. Shutter 162B includes substantially rectangular perforations 160B. Although the perforations are illustrated with example shapes and in example patterns on the shutter, perforations may take any geometric shape, and may be arranged on the shutter in any suitable pattern, including perforations/holes of varying sizes, arranged in regular or irregular patterns, and/or be arranged closer or farther from one end or side than another. Thus, employing perforations provides greater control to regulate airflow by and through the shutters.

FIG. 7 is a perspective view of the example vacuum system of FIG. 1 employing a plurality of shutters. As shown, a first shutter 152 is arranged at an end of the inlet flange 122 near the damper coupling 112. In this example, shutter 152 includes crimps, which help fix the position of the shutter at the end of the inlet flange. A second shutter 152B is arranged adjacent the first shutter 152, but is formed without crimps. This allows the second shutter 152B to be moved to a desired location along the inlet flange.

A third shutter 152A can be arranged along the inlet flange such that a gap is created between the second and third shutters. As shown, the third shutter 152A includes a fastener 166. The fastener 166 can be a crimp, a screw, a weld, adhesive, rivet, and/or a deformed part of the clip, as a list of non-limiting examples. The use of a fastener can allow an installer to locate one or more shutters anywhere along a length of the inlet flange, and then fixing the location. In some examples, the fastener 166 is removable.

Although several examples and/or embodiments are described with respect to a vacuum system for cleaning a material, the principles and/or advantages disclosed herein can employ technologies that are not limited to a particular type of material and/or application.

When introducing elements of various embodiments described below, the articles “a,” “an,” and “the” are intended to mean that there are one or more of the elements. The terms “comprising,” “including,” and “having” are intended to be inclusive and mean that there may be additional elements other than the listed elements. Moreover, while the term “exemplary” may be used herein in connection to certain examples of aspects or embodiments of the presently disclosed subject matter, it will be appreciated that these examples are illustrative in nature and that the term “exemplary” is not used herein to denote any preference or requirement with respect to a disclosed aspect or embodiment. Additionally, it should be understood that references to “one embodiment,” “an embodiment,” “some embodiments,” and the like are not intended to be interpreted as excluding the existence of additional embodiments that also incorporate the disclosed features.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

While only certain features of the invention have been illustrated and described herein, many modifications and changes will occur to those skilled in the art. It is, therefore, to be understood that the appended claims are intended to cover all such modifications and changes as fall within the true spirit of this disclosure.

What is claimed is:

1. An adjustable vacuum system for cleaning an object comprising:
an inlet flange having a first end and a second end, the inlet flange configured to connect to a vacuum collector system; and
one or more shutters configured to be mounted to the inlet flange and arranged to adjust a size of an air inlet of the inlet flange at one or more locations along the length.

2. The system of claim 1, wherein the inlet flange further comprises one or more flange lips arranged on one or more sides of the air inlet along the length of the inlet flange.

3. The system of claim 2, wherein each shutter of the one or more shutters includes one or more clips on one or more sides of the shutter, the one or more clips configured to secure the shutter to the one or more flange lips.

4. The system of claim 3, wherein the one or more flange lips includes a first flange lip and a second flange lip, the first flange lip arranged along a first side of the inlet flange and the second flange lip arranged along a second side of the inlet flange.

5. The system of claim 4, wherein the air inlet is arranged between the first flange lip and the second flange lip along the length of the inlet flange.

6. The system of claim 4, wherein the one or more clips includes a first clip and a second clip, the first clip arranged along a first side of the shutter and the second clip arranged along a second side of the shutter.

7. The system of claim 6, wherein the one or more shutters are configured to be mounted on the inlet flange by mounting the first clip to the first flange lip and the second clip to the second flange lip.

8. The system of claim 6, wherein each of the one or more shutters further comprises a base between the first clip and the second clip, the base configured to at least partially block access to the air inlet when the one or more shutters are mounted to the inlet flange.

9. The system of claim 6, wherein each of the one or more shutters further comprises one or more crimps at an end of the first or second clip of the shutter, the one or more crimps configured to connect to the first or second flange lip at the first or second end of the inlet flange to fix a position of the shutter at the first or second end.

10. The system of claim 1, wherein the one or more shutters are removably mounted to the inlet flange.

11. The system of claim 1, wherein the one or more shutters includes a first shutter and a second shutter, the first shutter configured to be mounted at the first or second end of the inlet flange, and the second shutter configured to be mounted to the inlet flange between the first and second ends.

12. The system of claim 11, further comprising a fastener to clamp the second shutter to the inlet flange to fix a position of the second shutter on the inlet flange.

13. The system of claim 1, wherein the one or more shutters includes a first shutter and a second shutter, the first shutter having a first length greater than a second length of the second shutter.

14. An adjustable vacuum system for cleaning an object comprising:
an inlet flange having a first end and a second end, the inlet flange configured to connect to a vacuum collector system; and
one or more shutters comprising one or more perforations, the one or more shutters configured to be mounted to the inlet flange and arranged to adjust a size of an air inlet of the inlet flange at one or more locations along the length.

15. The system of claim 14, wherein the one or more perforations includes one or more holes through a base of the one or more shutters.

16. The system of claim 15, wherein the one or more holes are in the shape of a circle, a rectangle, a triangle, a square, or a slit.

17. The system of claim 15, wherein the one or more perforations are distributed in a regular pattern about the base.
